(19) United States
(12) Patent Application Publication
(10) Pub. No.: US 2012/0271694 A1
(43) Pub. Date: Oct. 25, 2012

(54) REWARD POINTS MANAGEMENT SYSTEM AND METHOD

(75) Inventors: Keon Su Lee, Seongnam-si (KR); Choong Hee Lee, Seongnam-si (KR)

(73) Assignee: NHN BUSINESS PLATFORM CORPORATION, Seongnam-si (KR)

(21) Appl. No.: 13/272,612

(22) Filed: Oct. 13, 2011

(30) Foreign Application Priority Data
Oct. 13, 2010 (KR) 10-2010-0099856
Oct. 13, 2010 (KR) 10-2010-0099857
Nov. 8, 2010 (KR) 10-2010-0110300

(51) Int. Cl. G06Q 30/02

(52) U.S. Cl. 705/14.23

(57) ABSTRACT

A reward points management system and a method for reward points management provide a user with rewards points for transactions between the user and an advertiser. The reward points management system includes a maximum reward points determination unit to determine a maximum amount of reward points based on advertising expense for a specified period of an advertiser allowed to provide reward points; and a reward points determination unit to determine reward points for each user based on a payment remunerated by the user on a product or service of the advertiser and the maximum amount of reward points allotted.

### CROSS-REFERENCE TO RELATED APPLICATIONS

This application claims priority from and the benefit of Korean Patent Application Nos. 10-2010-0099856, 10-2010-0099857, and 10-2010-0110300 filed on Oct. 13, 2010, Oct. 13, 2010, and Nov. 8, 2010, respectively, which are hereby incorporated by reference for all purposes as if fully set forth herein.

### BACKGROUND OF THE INVENTION

1. Field of the Invention

Exemplary embodiments of the present invention relate to a reward points management system and method for providing reward points to a user with regard to a transaction between the user and an advertiser.

2. Discussion of the Background

In a conventional reward points management method, reward points are determined based on a price of a product or service which is being sold when a user is provided with the product or service, i.e., upon a payment being made. Thus, reward points are generally proportional to a payment for products or services which are being sold. In particular, if a reward rate with respect to a payment on a product or service sold is the same for all products or services, a total amount of reward points would be linearly proportional to a total payment. Even if a reward rate with respect to a payment is different for each product or service, the total amount of reward points would be virtually in linear proportion to a total payment amount.

In other words, in a conventional reward points management method, the source of reward points is a payment. Therefore, the greater a total payment amount is, the more the total amount of reward points increases, and thus a reward rate of reward points with respect to a payment may be fixed. Namely, a conventional reward points management method may readily determine a reward rate before a product or service is sold and may notify a user of the determined reward rate in advance.

However, if a source of reward points is not a payment, for example, if reward points are provided at a specific rate of a payment in each transaction but the total amount of reward points is obtained from other sources, it is difficult to determine an amount of reward points or a reward rate based on a payment. In particular, if the total amount of reward points is provided at a rate which is not based on a payment and if total reward points are fixed, it is difficult to determine how many reward points should be provided or a value of a reward rate to be applied with respect to a payment amount.

### SUMMARY OF THE INVENTION

Exemplary embodiments of the present invention provide a system and a method of managing reward points efficiently when a source of the reward points is not a payment amount.

Exemplary embodiments of the present invention also provide a reward points management system and a reward points management method which provides reward points to a user if the user purchases a product or service of an advertiser through a displayed advertisement of the advertiser.

Exemplary embodiments of the present invention also provide a reward points management system and a reward points management method which determines a maximum amount of reward points based on advertising expenses of an advertiser for a specified period and divides the maximum amount of reward points based on a rate of a payment remunerated by a user.

Exemplary embodiments of the present invention also provide a reward points management system and a reward points management method which determines a reward rate with respect to a payment remunerated by a user using an estimated advertising expense and an estimated payment for a current specified period, estimated based on actual advertising expense, and an actual payment remunerated for a previous specified period.

Exemplary embodiments of the present invention also provide a reward points management system and a reward points management method which maintains reward points of a user by supplying excess reward points or stopping a display of reward information and reward points to a user depending on a choice of the advertiser if a sum of reward points exceeds a maximum amount of reward points.

Additional features of the invention will be set forth in the description which follows, and in part will be apparent from the description, or may be learned by practice of the invention.

An exemplary embodiment of the present invention discloses a reward points management system including: a storage medium; a maximum reward points determination unit stored on the storage medium and configured to determine a maximum amount of reward points of an advertiser allowed to provide reward points on a site, the maximum amount of reward points being based on an advertising expense for a specified period; and a reward points determination unit stored on the storage medium and configured to determine an amount of reward points for a user based on a payment remunerated by the user on a product or service of the advertiser and the determined maximum amount of reward points.

An exemplary embodiment of the present invention also discloses a reward points management method including: determining a maximum amount of reward points of an advertiser allowed to provide reward points through a first site, the maximum amount of rewards points being based on an advertising expenses for a specified period; determining an amount of reward points for a user based on a payment remunerated by the user for a product or service of the advertiser through a second site; and deducting an amount of reward points from determined reward points of the user.

An exemplary embodiment of the present invention also discloses a rewards point management system including: in a non-transitory computer readable medium: a maximum reward points determination unit to determine a maximum amount of reward points of an advertiser for purchases made through a site, the maximum amount of rewards points being based on an advertising expense for a specified period; a reward points determination unit to determine reward points for a user who purchases the advertiser's products or services through the site based on a payment remunerated by the user for the product or service of the advertiser and the determined maximum amount of reward points; a reward points addition unit to add the determined amount of reward points to a total amount of reward points of the user; and a reward points deduction unit to deduct used reward points from the total amount of reward points of the user based on information received from the site in response to a product or service being purchased on the site using the reward points of the user.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates relations between an advertiser, an advertisement platform, a publisher, and a user according to an exemplary embodiment of the present invention.

FIG. 2 illustrates relations between a member, a member store, and a reward points management system according to an exemplary embodiment of the present invention.

FIG. 3, FIG. 4, FIG. 5, FIG. 6, FIG. 7, and FIG. 8 illustrate screens of websites displaying advertisements of advertisers according to an exemplary embodiment of the present invention.

FIG. 9 illustrates an order page of a website associated with an advertiser according to an exemplary embodiment of the present invention.

FIG. 10 is a flowchart illustrating a method for reward points management according to an exemplary embodiment of the present invention.

FIG. 11 is a block diagram illustrating a reward points management system according to an exemplary embodiment of the present invention.

FIG. 12 is a flowchart illustrating a method for reward points management according to an exemplary embodiment of the present invention.

FIG. 13 is a block diagram illustrating a reward points management system according to an exemplary embodiment of the present invention.

FIG. 14 is a flowchart illustrating a method for reward points management according to an exemplary embodiment of the present invention.

FIG. 15 is a block diagram illustrating a reward points management system according to an exemplary embodiment of the present invention.

FIG. 16 illustrates a webpage provided to an advertiser according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as being limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, when an element or layer is referred to as being “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

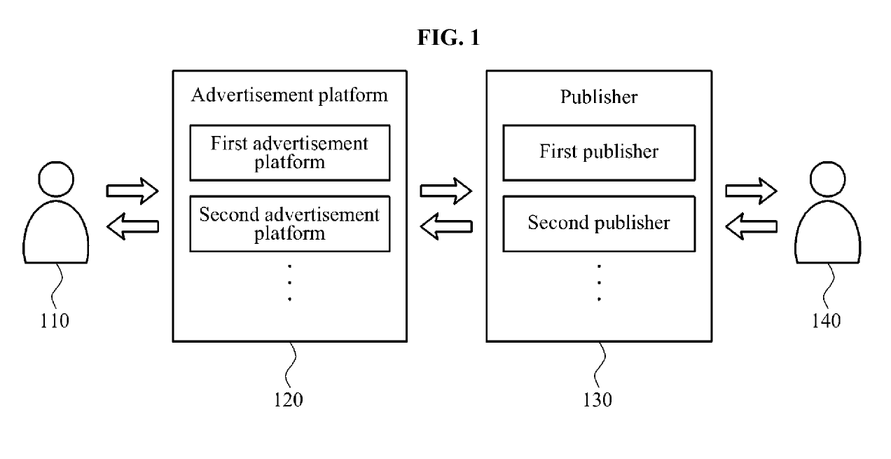

FIG. 1 illustrates relations between an advertiser, an advertisement platform, a publisher, and a user according to an exemplary embodiment of the present invention.

FIG. 1 depicts an advertiser 110, an advertisement platform 120, a publisher 130, and a user 140. The advertiser 110 and the user 140 may actually refer to terminals used by the advertiser 110 and the user 140, respectively, such as, personal computers (PCs), smart phones, etc. Arrows in FIG. 1 refer to transmission and reception of data performed through a wire-based or wireless network among a terminal used by the advertiser 110, the advertisement platform 120, a publisher 130, and a terminal used by the user 140.

The advertisement platform 120 may enable bidding by the advertiser 110 for an advertisement, match an advertisement and a keyword, arrange advertisements or advertisers, provide advertisements to the publisher 130, and charge for displayed advertisements. Technical details of the advertisement platform 120 are generally understood with respect to search advertisements and/or banner advertisement platforms transmitted via the Internet, and descriptions thereof are omitted for conciseness.

In the specification, the term “publisher” may be substituted for by the term “site.” The present invention should not be construed as implemented only in environments in which a connection to a website is generally made through a general PC. It should be noted that the present invention may also be implemented on applications executed in mobile terminals. On the other hand, the term “site” may be replaced with the term “publishing site” or “publisher.” In other words, each site may correspond to an individual publisher. The term “site” may include any website which can display advertisements and is provided to a user through a wire-based or wireless network and may also include one webpage constituting a website.

Further, a “display” of an advertisement may include promoting contents, such as, text, images, sounds, videos, and hyperlinks associated with an advertiser, to a visitor of a site through the site (publisher). Further, “selection” of a displayed advertisement refers to a user (site visitor) click on provided promoting contents, such as, text and images, in response to the displayed advertisement. The selection of a displayed advertisement results in the intention of an advertiser when transmitting promoting contents to be achieved. An intention of the advertiser may include, for example, a display of a page associated with the advertiser to the user who selected the advertisement.

The publisher 130 may provide its own site to the user 140, provide pages included in a site through the site, or provide search results of a keyword through input of the keyword to the user 140. Here, the publisher 130 receives advertisements to be displayed through pages from the advertisement platform 120 and provides them to the user 140. Further, the publisher 130 may transmit a keyword input by the user 140 to the advertisement platform 120, or receive an advertisement with respect to a keyword from the advertisement platform 120 and provide them to the user 140 as a search result.

The publisher 130 may provide a route (screen) of an advertisement provided directly to the user 140, and advertisements may be provided through websites in general online environments. Here, each of a plurality of separate advertisement platforms (first advertisement platform, second advertisement platform, and so forth) included in the advertisement platform 120 may display an advertisement through at least one separate publisher among a plurality of separate publishers (first publisher, second publisher, and so forth) included in the publisher 130. Further, each of the separate publishers may provide to the user 140 at least one of various services provided through a wire-based or wireless network, such as, unified searches, keyword searches, and blog services, as well as a display of the advertisement through at least one site.

The reward points management system according to an exemplary embodiment of the present invention may be one system among systems operating on a separate advertisement platform or a system included in one system among systems operating on a separate advertisement platform. The reward points management system may receive and use information about a user from at least one system among systems associated with a separate publisher.

Further, the reward points management system may be one system among systems associated with a separate publisher or a system included in one system among systems associated with a separate publisher. The reward points management system may receive and use information associated with an advertiser from at least one system among systems operating on a separate advertisement platform.

The reward points management system may receive information directly from the advertiser 110 or the user 140, or may receive information through at least one of a corresponding advertisement platform and a corresponding publisher. However, in the following description, only a reward points management system and a reward points management method will be described, without describing relations with an advertisement platform or a publisher for convenience and conciseness.

In the specification, the term “reward point” may be expressed in monetary units used in the real world but may be expressed in a cyber currency, such as, a point or mileage, corresponding to a currency used in the real world as necessary. For example, cyber currencies valued at 1:1, 1:10, or the like with respect to a real world currency may be optionally used as necessary. Reward points may be provided to the user 140 when the user 140 purchases a product or service of the advertiser 110. Further, the term “reward rate” refers to a ratio of reward points provided to the user 140 to a payment remunerated by the user 140 for a purchase of a product or service of the advertiser 110.

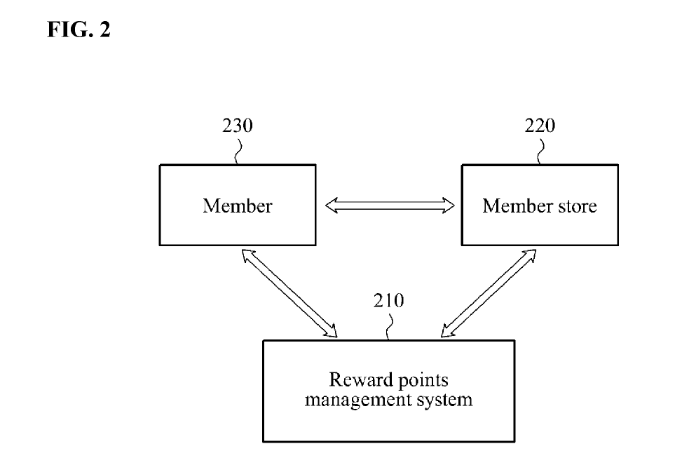

FIG. 2 illustrates relations between a member, a member store, and a reward points management system according to an exemplary embodiment of the present invention.

FIG. 2 schematically illustrates relations between a reward points management system 210, a member store 220, and a member 230. The member store 220 may refer to a site of an advertiser which is accepted for affiliation through a site associated with the reward points management system 210 among the advertisers 110 of FIG. 1. The member 230 may refer to a user who registers as a member through a site associated with the reward points management system 210 among the users 140 of FIG. 1.

If the member 230 selects and accesses the member store 220 on a site associated with the reward points management system 210 and purchases a product or service, the reward points management system 210 provides a specific amount of the payment for the purchased product or service as reward points. In an exemplary embodiment, reward points may be provided, for example, when the member 230 registers in the member store 220, as well as if the member 230 purchases a product or service in the member store 220. An amount may be set as a payment in advance.

The source of reward points provided by an administrator of the reward points management system 210 may not be a payment for a product or service of the member store 220 but may be an advertising expense paid by the member store 220. An amount of reward points is determined at a specific ratio of a payment but the source of the reward points is an advertising expense, and thus a total amount of reward points may not be proportional to a total number of payments. Thus, as described in the foregoing, it may be difficult to determine a reward rate based on a payment. For example, if 1% of a payment is provided in advance as reward points, the amount of reward points with respect to a product valued at 1,000,000 won is 10,000 won. However, a number of products to be sold during a specified period (for example, for one month) may be unpredictable. If a maximum amount of reward points that may be allotted is 50,000 won and 10 products are sold, the amount of reward points to be provided is 100,000 won, but that amount of reward points exceeds the maximum amount of reward points allotted. Thus, if the source of reward points is not a payment, for example, if the maximum amount of reward points is determined based on advertising expenses, there is a need for a different method of determining reward points.

The maximum amount of reward points may be determined based on advertising expenses of the member store 220 for a specified period and an amount of reward points may be determined based on payments of users and the maximum amount of reward points. For example, the reward points management system 210 sets a % of advertising expenses paid at the end of each month as the maximum amount of reward points and divides the maximum amount of reward points based on a ratio of a payment of each member 230 to a total number payments of all members. The users may be provided with reward points with respect to payments at the end of each month.

Table 1 illustrates reward points to be provided to each member if three members purchase products or services of a particular member store for a specified period.

TABLE 1

| | Member 1 | Member 2 | Member 3 | Total |
|---|---|---|---|---|
| Payment | 1,000,000 | 2,000,000 | 7,000,000 | 10,000,000 |
| Payment ratio | 1/10 | 2/10 | 7/10 | 1 |
| Total advertising | 1,000,000 | | | |
| expenses | | | | |
| Maximum reward | 20,000 (1,000,000 * 0.02) | | | |
| points | | | | |
| Individual reward | 2,000 | 4,000 | 14,000 | 20,000 |
| points | (20,000 * | (20,000 * | (20,000 * | |
| | 1/10) | 2/10) | 7/10) | |

The reward points management system 210 determines a specific ratio of total advertising expenses to be a maximum amount of reward points and divides the maximum amount of reward points based on a ratio of each member's payment to total payments, thereby determining an individual reward point.

If the member 230 purchases a product or service in the member store 220 using reward points, the reward points management system 210 deducts an amount of reward points to be paid by the member 230 and provides the deducted amount to the member store 230.

A reward rate for a current specified period may be determined using data to measured for a previous specified period and data estimated for the current specified period. In detail, the reward points management system 210 may include a reward rate determination unit which determines a reward rate to be applied to users for the current specified period. The reward rate may be estimated using estimated advertising expenses for the current specified period and real advertising expenses for the previous specified period with respect to advertisers allowed to provide reward points, and estimated payments on products or services of the advertisers to be paid by users for the current specified period.

Advertising expenses paid by advertisers to display advertisements may be the source of reward points provided to users. Thus, an estimated maximum amount of reward points to be provided for a current specified period may be determined based on real advertising expenses for a previous specified period and estimated advertising expenses for the current specified period. Thus, a reward rate indicating how many reward points are provided with respect to a payment used by a user may be determined using estimated payments.

The maximum amount of reward points for the current specified period may be determined based on estimated advertising expenses of an advertiser allowed to provide reward points for the current specified period. If a user purchases a product or service of the advertiser for the current specified period, an amount of reward points may be determined with respect to purchase of the user using a reward rate determined by the advertiser based on a payment remunerated by the user. In other words, a reward rate that is a ratio of reward points to a payment may be determined by the advertiser. For example, the advertiser may determine that a reward rate is 1% of a payment. A user who purchases a product or service of the advertiser is provided with 1% of a payment as a reward point. However, since a maximum amount of reward points is determined based on advertising expenses of an advertiser, if users frequently purchase products or services, reward points may exceed the maximum amount of reward points.

Therefore, reward points may be provided with respect to purchases only before a total amount of reward points determined for the current specified period exceeds a maximum amount of reward points. In other words, reward points may be provided if a total amount of reward points determined for the current specified period is equal to or less than the maximum amount of reward points, which will be described in detail in below.

Further, reward points are provided with respect to all purchases made for the current specified period, but reward points exceeding the maximum amount of reward points may be covered by the advertiser. If a total amount of reward points determined for the current specified period exceeds the maximum amount of reward points, an excess of reward points may be provided by the advertiser. Since advertising effects may be increased through provision of reward points, advertisers who desire to provide reward points cover an excess of reward points, thereby continually providing reward points to users for the current specified period.

Since a reward rate is determined by advertisers, information needed to determine a reward rate may be provided to the advertisers in exemplary embodiments of the present invention.

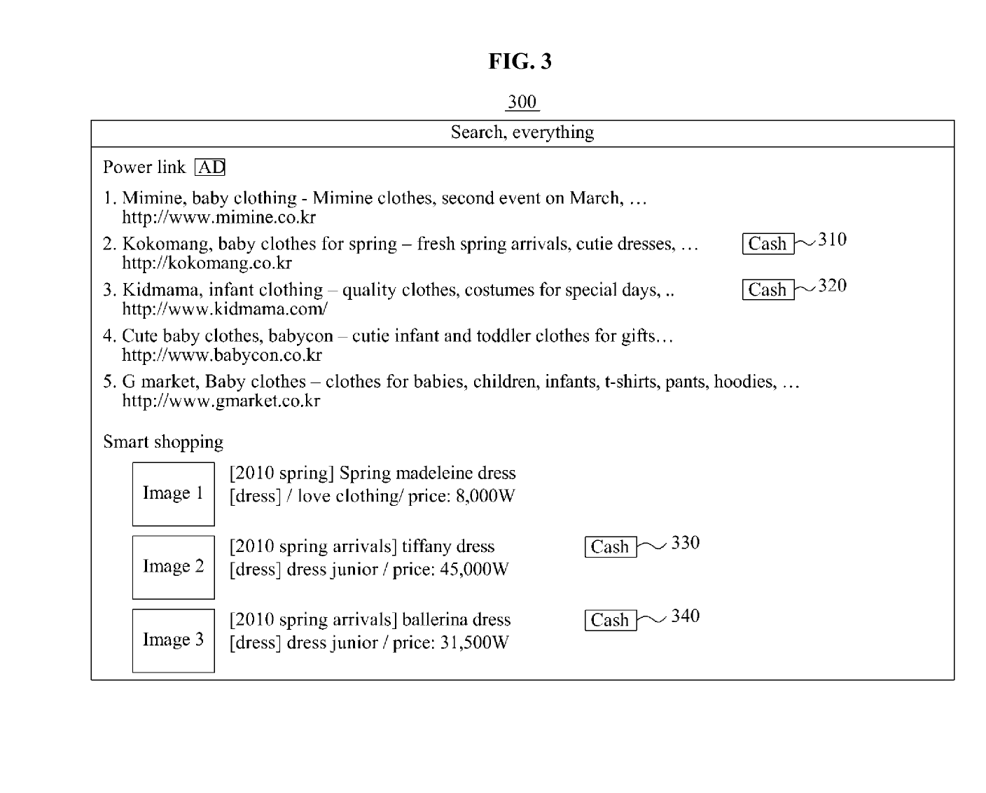

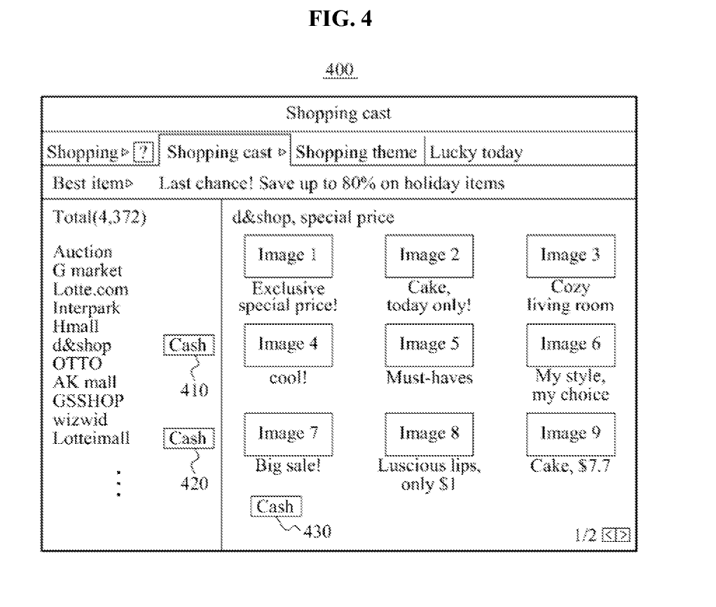

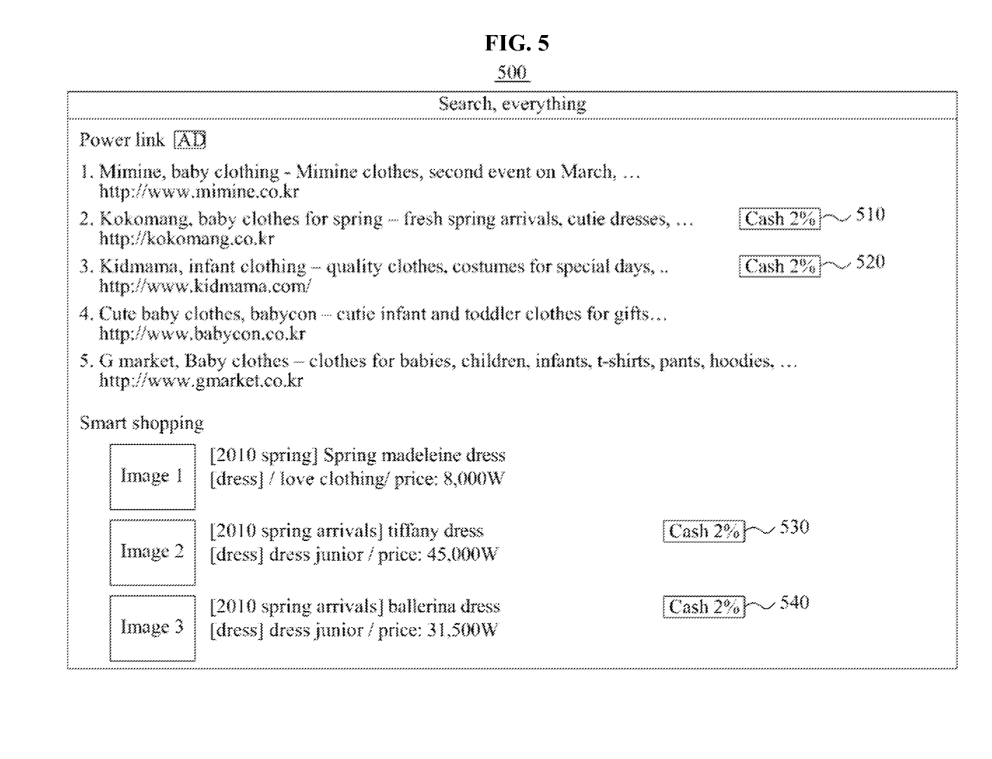

FIG. 3, FIG. 4, FIG. 5, FIG. 6, FIG. 7 and FIG. 8 illustrate examples of screens of sites displaying advertisements of advertisers according to an exemplary embodiment of the present invention.

A screen 300 shown in FIG. 3 illustrates part of a screen of a site (publisher) displaying advertisements of the advertiser 110 described with reference to FIG. 1. Individual advertisements indicated by “Cash” icon 310, “Cash” icon 320, “Cash” icon 330, and “Cash” icon 340 denote advertisements to provide reward points, described with reference to FIG. 1 and FIG. 2. Advertisements of advertisers who are accepted for affiliation and thus allowed to provide reward points may be displayed with the “Cash” icons 310, “Cash” icon 320, “Cash” icon 330, and “Cash” icon 340.

If the member 230 of FIG. 2 accesses a particular site through a link in the advertisements indicated by the “Cash” icon 310, “Cash” icon 320, “Cash” icon 330, and “Cash” icon 340 and purchases a product or service, the member 230 may be provided with a specific amount of a payment as reward points. According to an exemplary embodiment, if the member 230 purchases a product or service on the site in a specified period (for example, one month), the member 230 may be provided with the reward points after the specified period.

A screen 400 shown in FIG. 4 illustrates part of a screen of a site (publisher) displaying advertisements of the advertiser 110 described with reference to FIG. 1. On the screen 400, “Cash” icon 410 and “Cash” icon 420 may be rewards point set for entire stores of particular advertisers and not for each individual product. The “Cash” icon 410 and “Cash” icon 420 are reward points that are related to all products or services sold in a store or site of a particular advertiser. “Cash” icon 430 is for reward points that may be set for an individual product or service.

A screen 500 shown in FIG. 5 illustrates part of a screen of a site (publisher) displaying advertisements of the advertiser 110 described with reference to FIG. 1. Individual advertisements indicated by “Cash 2%” icon 510, “Cash 2%” icon 520, “Cash 2%” icon 530, and “Cash 2%” icon 540 denote advertisements to provide reward points, described with reference to FIG. 1 and FIG. 2. Advertisements of advertisers who are accepted for affiliation and thus allowed to provide reward points may be displayed with the “Cash 2%” icons 510, “Cash 2%” icon 520, “Cash 2%” icon 530, and “Cash 2%” icon 540. The “2%” refers to a reward rate, described with reference to FIG. 1 and FIG. 2, and the reward rate may be determined by the reward points management system 210 described with reference to FIG. 2.

If the member 230 of FIG. 2 accesses a particular site through links of the advertisements indicated by the “Cash 2%” icons 510, “Cash 2%” icon 520, “Cash 2%” icon 530, and “Cash 2%” icon 540 and purchases a product or service, the member 230 may be provided with 2% of a payment amount as reward points. A reward rate refers to a ratio of reward points to a payment remunerated by the user, but the source of the reward points is advertising expenses paid by advertisers to display advertisements. Thus, as described in the foregoing, the reward points management system 210 may use real advertising expenses from a previous specified period in order to determine a reward rate.

A screen 600 shown in FIG. 6 illustrates part of a screen of a site (publisher) displaying advertisements of the advertiser 110 described with reference to FIG. 1. On the screen 600, “Cash 2%” icon 610 and “Cash 2%” icon 620 are rewards points for an entire store of particular advertisers and are not for each individual product. In this case, the “Cash 2%” icons 610 and 620 refer to reward points that are set for all products or services sold in a store of a particular advertiser. A “Cash 2%” icon 630 is for reward points that may be set for an individual product or service.

A screen 700 shown in FIG. 7 illustrates part of a screen of a site (publisher) displaying advertisements of the advertiser 110 described with reference to FIG. 1. An to advertisement and a reward rate may be displayed on a site in the screen 700. As indicated by “Cash 1.5%” icon 710 and “Cash 1.5%” icon 720, a “Cash 1%” icon 730, and a “Cash 3%” icon 540, reward rates set by advertisers may be displayed in conjunction with advertisements.

If the member 230 of FIG. 2 accesses a particular site of an advertiser through an advertisement indicated by the “Cash 3%” icon 740 and purchases a product or service of the advertiser, the member 230 may be provided with 3% of a payment as reward points. A reward rate refers to a ratio of reward points to a payment remunerated by the user, but the source of the reward points is advertising expenses paid by advertisers to display advertisements. In other words, reward points are generated at a reward rate based on total payments for products or services of the advertiser sold during a specified period, and a maximum amount of reward points is determined based on advertising expenses paid by the advertiser.

Thus, a total amount of reward points generated for the current specified period with respect to the advertiser may be limited so as not to exceed the maximum amount of reward points allocated. For example, if it is determined that the total amount of reward points exceeds the maximum amount of reward points for a specific period, the “Cash 3%” icon 740 may not be displayed when displaying the advertisement.

In an exemplary embodiment, the “Cash 3%” icon 740 is continually displayed for the current specified period, and if total reward points exceed the maximum reward points, the advertiser covers an excess. For example, free charge points equivalent to the maximum amount of reward points are provided to the advertiser to be used as reward points, and if free charge points are insufficient, paid charge points charged to the advertiser may be used as reward points.

A screen 800 shown in FIG. 8 illustrates part of a screen of a site (publisher) to displaying advertisements of the advertiser 110 described with reference to FIG. 1. On the screen 800, a “Cash 2%” icon 810 and a “Cash 3%” icon 820 are for rewards points that may be set for entire stores of particular advertisers to provide reward points and are not for each individual product. In other words, reward points may be provided at a reward rate with respect to all products or services sold in a store of a particular advertiser. “Cash 3%” icon 830 refers to reward points that may be set for an individual product or service.

As described in the foregoing with reference to FIG. 3, FIG. 4, FIG. 5, FIG. 6, FIG. 7 and FIG. 8, if reward points management systems or reward points management methods according to the exemplary embodiments are used, reward points are provided to users if particular products or services, or products or services included in a particular site or store are purchased, and may thereby draw the attention of users and may accordingly improve the efficiency of advertising of member advertisers. Further, a medium that attracts the interests of advertisers with increasing advertising efficiency and thus earns advertising revenue.

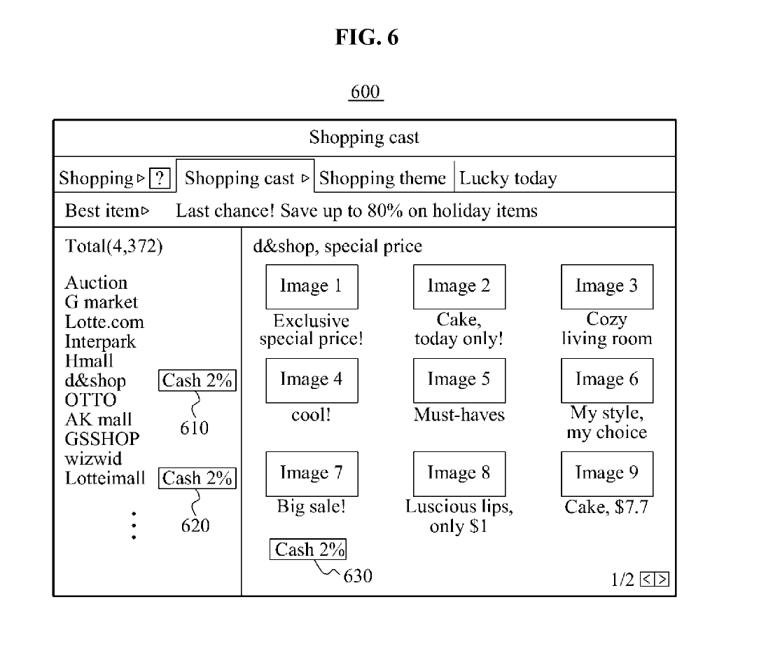

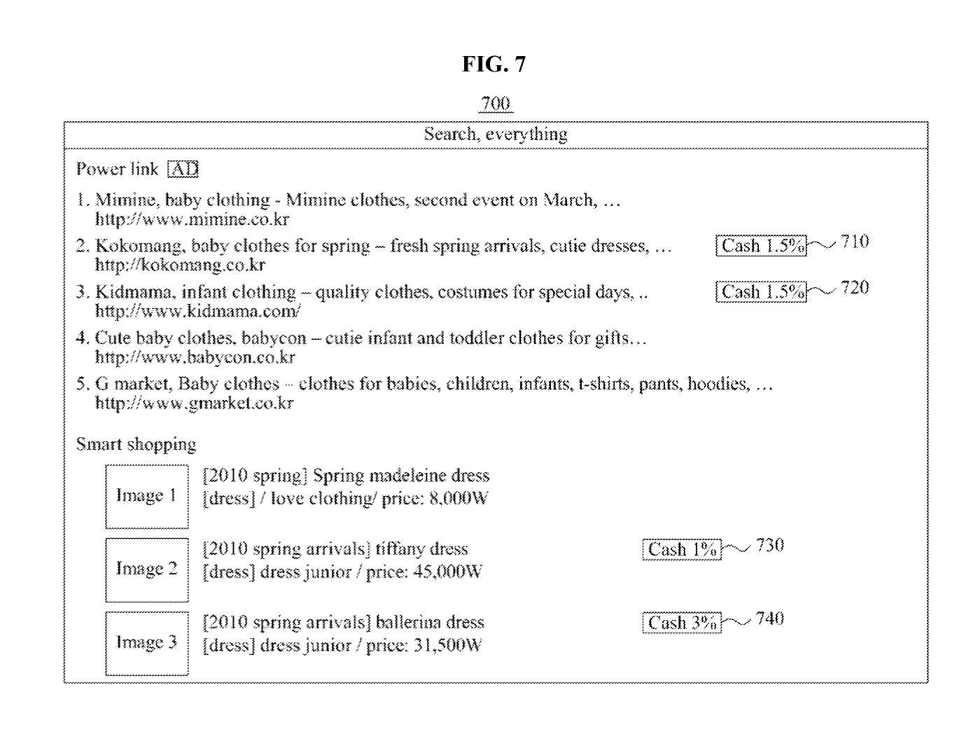

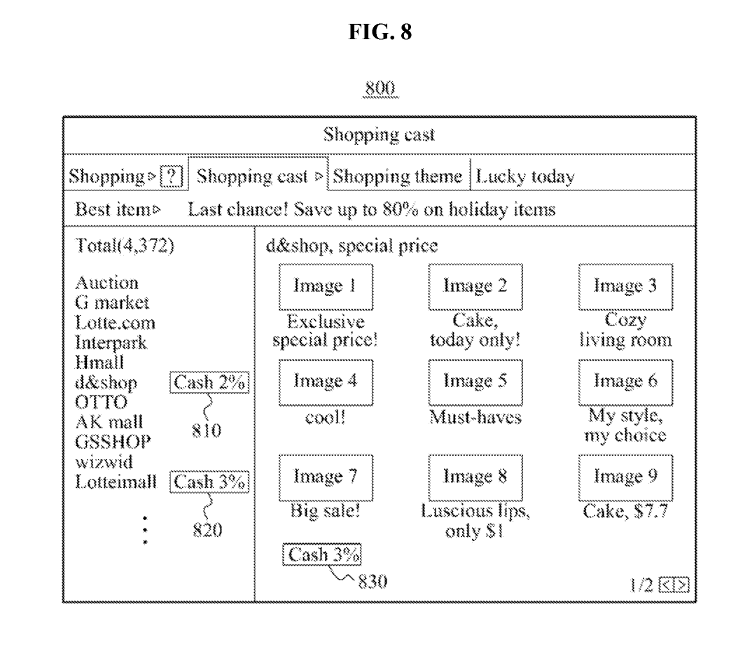

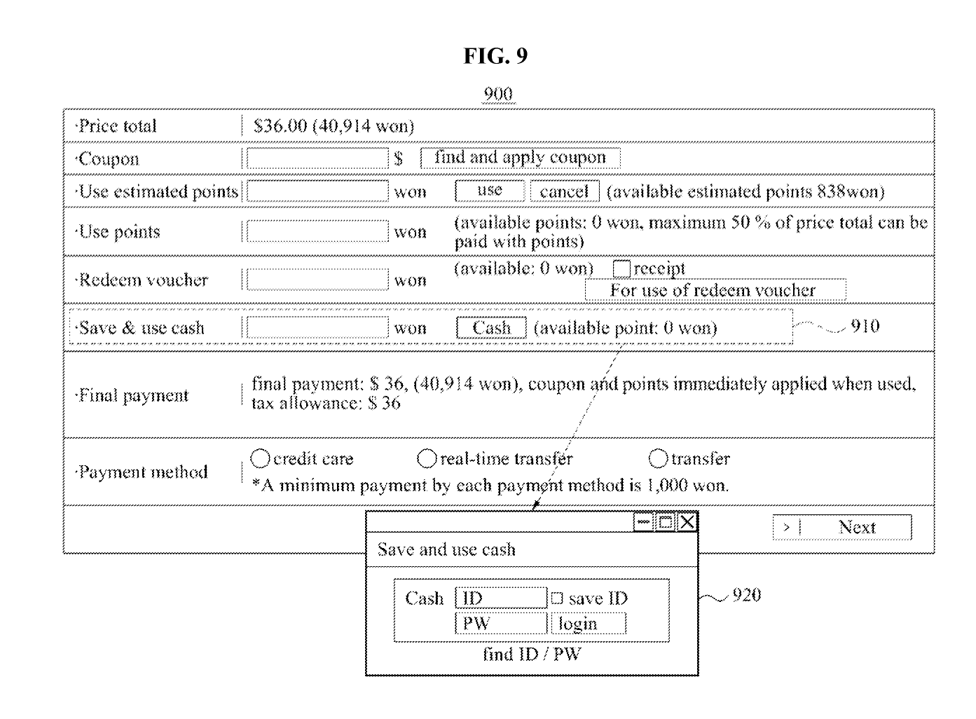

FIG. 9 illustrates an example of an order page of a website associated with an advertiser according to an exemplary embodiment of the present invention.

A screen 900 displays an example of part of an order page of a particular member store. A first dotted-line box 910 shows an icon indicating that reward points are accumulated and a user interface for use of reward points if reward points are already accumulated. For accumulation or use of reward points, a user may log in to a site associated with a reward points management system according to the present exemplary embodiment. A log in box 920 displays a user interface for log in to a site associated with the reward points management system. In other words, a user logs in through the login box 920 and is identified as an authorized member.

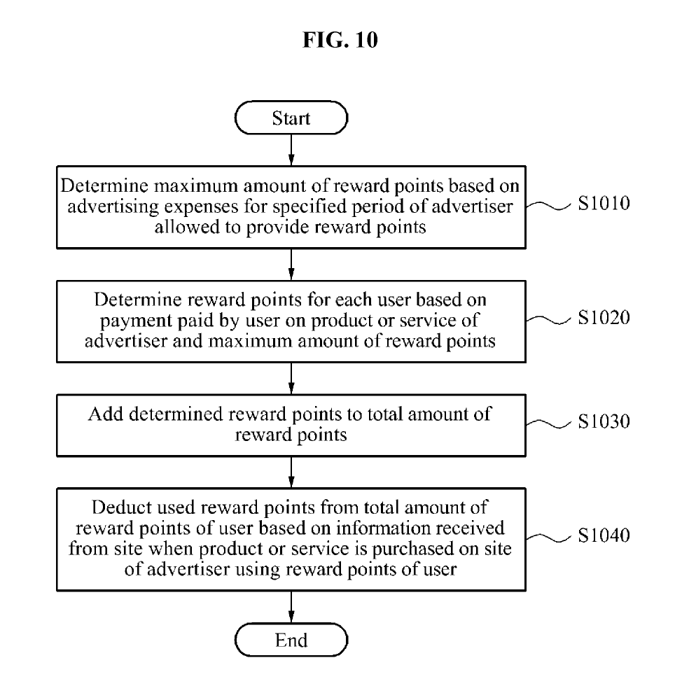

FIG. 10 is a flowchart illustrating a method for reward points management according to an exemplary embodiment of the present invention.

FIG. 10 illustrates each operation of the reward points management method conducted by the above-described reward points management system.

In operation S1010, the reward points management system determines a maximum amount of reward points based on advertising expenses for a specified period of an advertiser allowed to provide reward points. The advertiser allowed to provide reward points may include advertisers who apply for membership and are accepted as members among advertisers displaying advertisements through a particular site. Further, if an advertisement of an advertiser, accepted as a member, is provided to users through a particular site, information about the advertisement and reward points may be provided. In other words, the user learns that reward points are provided if a product or service in the advertisement is purchased.

The reward points management system may determine a specific ratio of advertising expenses for a specified period as the maximum amount of reward points for the specified period. For example, a maximum amount of reward points for a specified period to be provided to users who purchase products or services of a particular advertiser may be defined by Equation 1.

Maximum amount of reward points of advertiser A=Advertising expense of advertiser A for specified period×α [Equation 1]

Where, ‘α’ is the specific ratio, which may be a real number in the range from 0 to 1.

In operation S1020, the reward points management system determines an amount of reward points for each user based on a payment remunerated by the user for a product or service of an advertiser and the maximum reward points allotted. The reward points management system calculates a ratio of a payment remunerated by each user to total payments and divides the maximum amount of reward points of the advertiser by the calculated ratio, thereby determining reward points for each user. For example, reward points of a user B who purchases a product or service of an advertiser A may be calculated by Equation 2.

Amount of reward points of user B=Maximum amount of reward points of advertiser A×(payment of user B/total earnings advertiser A) [Equation 2]

Total earnings of the advertiser A refers to a sum of payments of users who purchase products or services of the advertiser A.

In operation S1030, the reward points management system adds the determined amount of reward points to a total amount of reward points of each user. In other words, the amount of reward points determined in operation S1020 is the amount of reward points for the specified period. Thus, the determined amount of reward points of each user may need to be added to the total amount of reward points of the user, and the reward points management system adds the amount of reward points for the specified period to the total amount of reward points in operation S1030.

In operation S1040, if a product or service is purchased on a site of the advertiser using reward points of the user, the reward points management system deducts used reward points from the total amount of reward points of the user based on information received from the site. For example, if a user A having total amount of reward points of 5,000 uses 3,000 to purchase a product on a site of a particular advertiser, the reward points management system deducts reward points 3,000 used for purchase of the product from total amount of reward points 5,000. Consequently, the user A has total amount of reward points equaling 2,000.

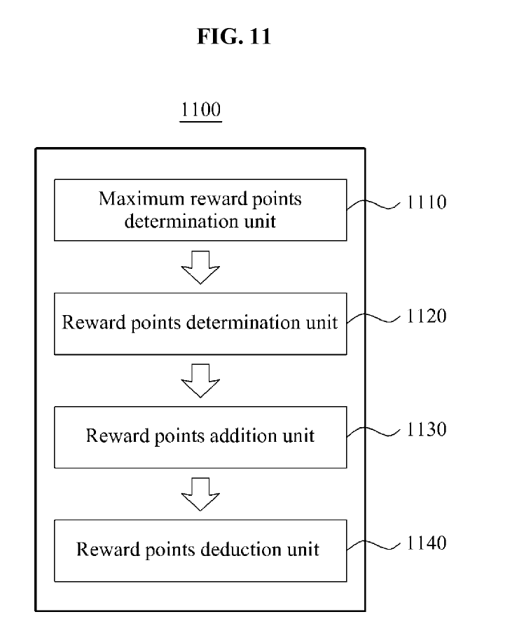

FIG. 11 is a block diagram illustrating a reward points management system according to an exemplary embodiment of the present invention.

As shown in FIG. 11, the reward points management system 1100 may include a maximum reward points determination unit 1110, a reward points determination unit 1120, a reward points addition unit 1130, and a reward points deduction unit 1140.

The maximum reward points determination unit 1110 may determine a maximum amount of reward points based on an advertising expense for a specified period of an advertiser allowed to provide reward points. The advertiser allowed to provide reward points may include advertisers who apply for membership and are accepted as members among advertisers displaying advertisements through a particular site. Further, if an advertisement of an advertiser, accepted as a member, is provided to users through a particular site information about the advertisement and reward points may be provided to the user. In other words, the user may learn that reward points are provided if a product or service in the advertisement is purchased.

The maximum reward points determination unit 1110 may determine a specific ratio of advertising expenses for a specified period as a maximum amount of reward points for the specified period. For example, the maximum amount of reward points for a specified period to be provided to users who purchase products or services of a particular advertiser may be defined by Equation 1.

The reward points determination unit 1120 determines reward points for each user based on a payment remunerated by the user on a product or service of an advertiser and the maximum amount of reward points. The reward points determination unit 1120 calculates a ratio of a payment remunerated by each user to total payments and divides the maximum amount of reward points of the advertiser by the calculated ratio, thereby determining an amount of reward points of each user. For example, an amount of reward points of a user B who purchases a product or service of an advertiser A may be calculated by Equation 2.

The reward points addition unit 1130 adds the determined amount of reward points to the total amount of reward points of each user. In other words, the amount of reward points determined by the reward points determination unit 1120 is the amount of reward points for the specified period. Thus, the determined amount of reward points for each user may need to be added to the total amount of reward points for the user, and the reward points addition unit 1130 adds the amount of reward points for the specified period to the total amount of reward points.

If a product or service is purchased on a site of the advertiser using reward points of the user, the reward points deduction unit 1140 deducts an amount of used reward points from the total amount of reward points of the user based on information received from the site. For example, if a user A having total amount of reward points equaling 5,000 uses 3,000 reward points to purchase a product on a site of a particular advertiser, the reward points deduction unit 1140 deducts 3,000 reward points used for the purchase of the product from the total amount of reward points 5,000. Consequently, the user A has total amount of reward points equaling 2,000.

FIG. 10 and FIG. 11 illustrate a method of determining maximum reward points of each individual advertiser allowed to provide reward points based on advertising expenses for a specified period. In an exemplary embodiment, a maximum amount of reward points of all advertisers may be determined instead of a maximum amount of reward points of each advertiser. The maximum amount of reward points is determined based on advertising expenses of all advertisers for a specified period, and an amount of reward points of each user is determined based on a payment remunerated by the user for a product or service of each advertiser and the maximum amount of reward points of all advertisers. For example, Equation 1 and Equation 2 may be modified into Equation 3 and Equation 4, respectively.

Maximum amount of reward points of all advertisers=Advertising expenses of all advertisers for specific period×α [Equation 3]

Amount of reward points of user C=Maximum amount of reward points of all advertisers×(payment of user C/total payments) [Equation 4]

Total payments may denote a sum of payments of all users who purchase at least one of products or services from all advertisers.

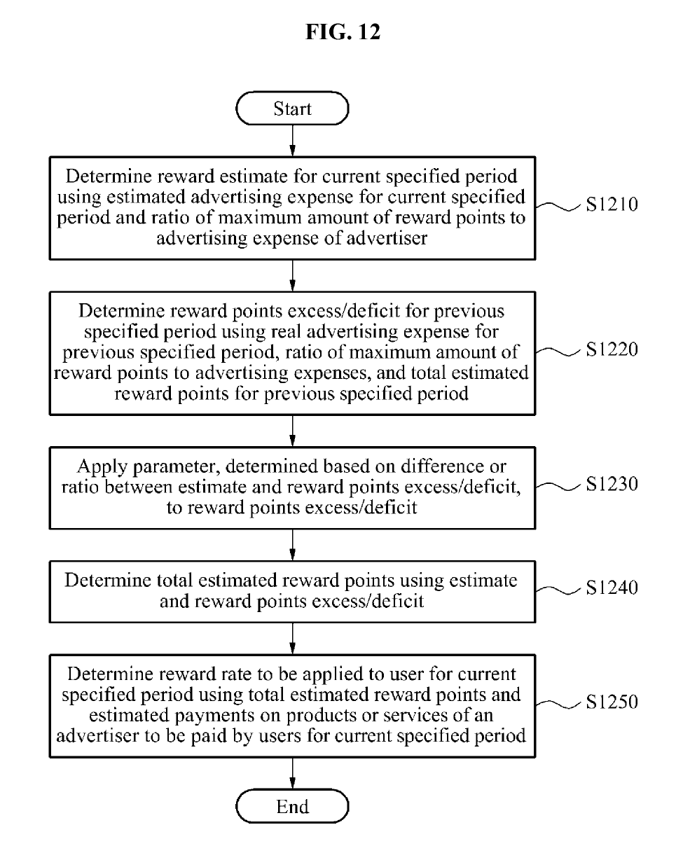

FIG. 12 is a flowchart illustrating a method for reward points management according to an exemplary embodiment of the present invention.

FIG. 12 illustrates operations of the reward points management method of the above-described reward points management system.

In operation S1210, the reward points management system determines a reward estimate for a current specified period using estimated advertising expense for the current specified period and a ratio of a maximum amount of reward points to advertising expense of an advertiser. For example, a reward estimate for a current specified period may be defined by Equation 5.

Reward estimate=AAₙ×α [Equation 5]

Where, ‘AAₙ’ denotes estimated advertising expense for an n^{th} specified period, and ‘α’ denotes a ratio of maximum amount of reward points to advertising expense of an advertiser and may be a real number in the range from 0 to 1. In other words, in Equation 5 if an n^{th} specified period is a current specified period, a specific ratio of estimated advertising expense for the current specified period is determined as a reward estimate. The specific ratio ‘α’ may be preset. For example, if an estimated advertising expense for a current specified period is is 1,000,000 won and a ratio ‘α’ of a maximum amount of reward points to the advertising expense is 0.1, a reward estimate is 100,000 won.

Further, the estimated advertising expense for a current specified period may be determined using a real advertising expense for a previous specified period and information about a change in the real advertising expense for each specified period. For example, an estimated advertising expense for a current specified period may be calculated by Equation 6.

AAₙ=ƒ(RAₙ₋₁,RAₙ₋₂,RAₙ₋₃, . . . ) [Equation 6]

Where, ‘RAₙ₋₁’ denotes the real advertising expense for an n−1^{th} specified period, and ‘f( )’ denotes a function to estimate estimated advertising expense for an n^{th} specified period based on real payments for previous specified periods including the n−1^{th} specified period and a change in a real payment for each specified period and may be one of various known functions.

However, a reward estimate may be different from reward points to be actually provided. In other words, since the source of reward points is advertising expenses and reward points are provided at a reward rate with respect to a payment by each user, an amount of reward points to be provided may fluidly change based on a number of transactions of users, and thus real reward points may be different from a reward estimate. To determine a difference, the reward points management system may conduct operation S1220 and operation S1230.

In operation S1220, the reward points management system determines a reward points excess/deficit for a previous specified period using a real advertising expense for the previous specified period, a ratio of a maximum amount of reward points to advertising expenses, and total estimated amount of reward points. The reward points excess/deficit denotes an amount of excessive or insufficient reward points for the previous specified period and may is be calculated by Equation 7, for example.

Reward points excess/deficit=(RAₙ₋₁×α)−Eₙ₋₁ [Equation 7]

Where, ‘RAₙ’ denotes a real advertising expense for an n^{th} specified period, and ‘Eₙ’ denotes a total estimated amount of reward points for an n^{th} specified period. In other words, when the n^{th} specified period is a current specified period, an amount of excessive or insufficient reward points for a previous specified period may be calculated by Equation 7 using a real advertising expense for the previous specified period, a ratio of a maximum amount of reward points to advertising expenses, and total estimated reward points for the previous specified period.

In operation S1230, the reward points management system applies a parameter to a reward points excess/deficit, wherein the parameter is determined based on a difference or ratio between an estimate reward points and a reward points excess/deficit. For example, a parameter ‘β’ may be applied to a reward points excess/deficit as shown in Equation 8.

Excessive/insufficient reward points=β×(RAₙ₋₁×α)−Eₙ₋₁) [Equation 8]

The parameter ‘β’ denotes a ratio at which a reward points excess/deficit for a previous specified period is applied to estimated reward points for a current specified period and may be a real number from 0 to 1. For example, if ‘β’ is 1, all excessive or insufficient reward points for the previous specified period are applied to a reward estimate. If ‘β’ is 0, excessive or insufficient reward points for the previous specified period are not applied to a reward estimate.

Operation S1230, in which the parameter is applied to a reward points excess/deficit, may be included in a reward points management method as necessary. Further, the parameter may be set by an administrator of the reward points management system.

In operation S1240, the reward points management system determines a total estimated amount of reward points using the estimate reward points and the reward points excess/deficit. Here, the reward points management system determines a total amount of estimated reward points for a current specified period using the estimate reward points and the parameter-applied reward points excess/deficit, as shown in Equation 9.

Eₙ=(AAₙ×α)+β×((RAₙ₋₁×α)−Eₙ₋₁) [Equation 9]

In other words, the reward points management system may apply the parameter-applied reward points excess/deficit to the reward estimate in Equation 9. If total a real amount of reward points are greater than a total estimated amount of reward points for a previous specified period, the second term in Equation 9 has a positive value. Thus, the total amount of estimated reward points for the current specified period may be determined to further have additional reward points for the previous specified period. On the contrary, if a total amount of real reward points is less than a total amount of estimated reward points for a previous specified period, the second term in Equation 9 has a negative value. In other words, the total amount of estimated reward points for the current specified period may be determined, excluding insufficient reward points from the previous specified period. The reward points management system may adjust data for the current specified period using data for the previous specified period.

In operation S1250, the reward points management system determines a reward rate using the total estimated reward points for the current specified period and estimated payments on products or services of an advertiser to be paid by users for the current specified period. For example, the reward rate may be determined by Equation 10.

$${F}_{n} = \frac{{E}_{n}}{{AS}_{n}} \qquad [ Equation 10 ]$$

Where, ‘Fₙ’ denotes a reward rate for an n^{th} specified period, and ‘ASₙ’ denotes an estimated payment for an n^{th} specified period. If the n^{th} specified period is a current specified period, the reward points management system determines a ratio of a total amount of estimated reward points for the current specified period to an estimated payment for the current specified period as a reward rate.

The estimated payment may be determined using a real payment for a previous specified period and information about a change in a real payment for each specified period. For example, an estimated payment for the current specified period may be calculated by Equation 11.

ASₙ=g(RSₙ₋₁,RSₙ₋₂,RSₙ₋₃, . . . ) [Equation 11]

Where, ‘RSₙ₋₁’ denotes a real payment for an n−1^{th} specified period, and ‘g( )’ denotes a function to estimate an estimated payment for an n^{th} specified period based on real payments for previous specified periods including the n−1^{th} specified period and a change in a real payment for each specified period and may be one of various known functions.

Although the foregoing method is described with reference to divided operations and separate equations for convenience, the reward points managements system may determine a reward rate through a single operation using a single reward rate estimation function. For example, a reward rate estimation function may be expressed by Equation 12 or Equation 13 using the aforementioned equations.

$$\begin{matrix}{F}_{n} = \frac{{E}_{n}}{{AS}_{n}} = \frac{[ ( {AA}_{n} \times α ) + β \times ( ( {RA}_{n - 1} \times α ) - {E}_{n - 1} ) ]}{{AS}_{n}} & [ Equation 12 ] \\ {F}_{n} = \frac{{E}_{n}}{{AS}_{n}} = \frac{[ \begin{matrix}( f ( {RA}_{n - 1} \times α ) + β \times \\ ( ( {RA}_{n - 1} \times α ) - {E}_{n - 1} )\end{matrix} ]}{g ( {RS}_{n - 1} )} & [ Equation 13 ]\end{matrix}$$

In FIG. 12, the reward points management system according to an exemplary embodiment determines a reward rate through four operation S1210, operation S1220, operation S1230, and operation S1240. However, a reward points management system according to an exemplary embodiment of the present invention may determine a reward rate through integration of these operations or using a different operation.

In other words, in order to perform a reward points management method, the reward points management system may determine total estimated reward points for a current specified period using an estimated advertising expense for the current specified period and real advertising expense for a previous specified period of an advertiser allowed to provide reward points (not shown) and determine a reward rate applied to users for the current specified period using the total estimated reward points and an estimated payment for products or services of an advertiser to be paid by users for the current specified period (not shown). Operation S1210, operation S1220, operation S1230, and operation S1240 may be included in determining the total amount of estimated reward points (not shown). For example, a total amount of estimated reward points is determined based on an estimated advertising expense for a current specified period but may be adjusted using a real advertising expense for a previous specified period, and a reward rate may be determined using the determined total estimate reward points and an estimated payment for the current specified period. In other words, the reward points management system may determine the total amount of estimated reward points for a current specified period using the estimated advertising expense and the real advertising expense and may determine a ratio of the total amount of estimated reward points to be the estimated payment as a reward rate.

The reward rate may include a ratio of reward points to a payment, and the advertiser allowed to provide reward points may include advertisers who apply for membership and are accepted as members among advertisers displaying advertisements through a particular site. Further, a user remunerating a payment may be provided with reward points. If an advertisement of an advertiser, accepted as a member, is provided to users through a particular site, information about the advertisement and a reward rate may be provided and a user purchasing a product or service of the advertiser through the advertisement may be provided with an amount of reward points corresponding to the reward rate.

Further, the reward points management system may determine the total amount of estimated reward points further using a ratio of a maximum amount of reward points to advertising expenses of an advertiser and total estimated reward points for a previous specified period.

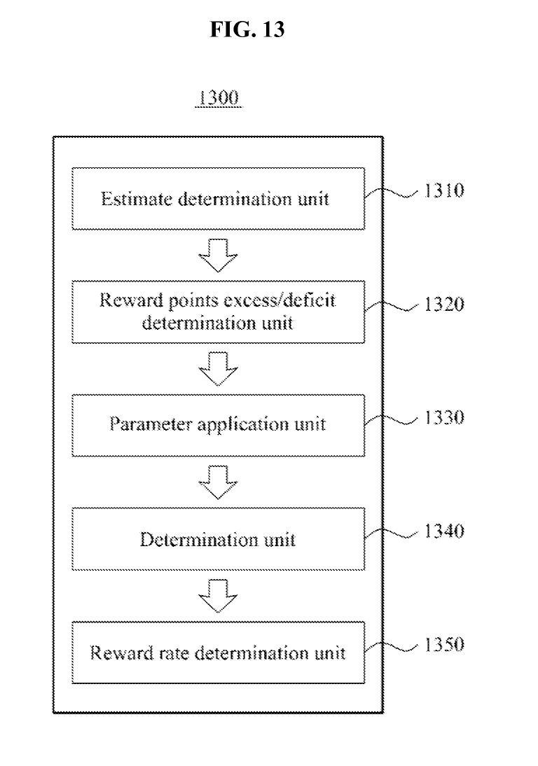

FIG. 13 is a block diagram illustrating a reward points management system according to an exemplary embodiment of the present invention. As shown in FIG. 13, the reward points management system 1300 may include an estimate determination unit 1310, a reward points excess/deficit determination unit 1320, a parameter application unit 1330, a determination unit 1340, and a reward rate determination unit 1350.

The estimate determination unit 1310 may determine a reward estimate for a current specified period using estimated advertising expenses for the current specified period and a ratio of a maximum amount of reward points to advertising expenses of an advertiser. For example, a reward estimate for a current specified period may be defined by Equation 5.

However, a reward estimate may be different from reward points to be actually provided. In other words, since a source of reward points is advertising expenses but reward points are provided at a reward rate with respect to a payment by each user, reward points to be provided may fluidly change based on a number of transactions of users, and thus an amount of real reward points may be different from a reward estimate. To determine a difference, the reward points management system 1300 may include the reward points excess/deficit determination unit 1320 and the parameter application unit 1330.

The reward points excess/deficit determination unit 1320 determines a reward points excess/deficit for a previous specified period using real advertising expense for the previous specified period, a ratio of a maximum amount of reward points to advertising expenses, and total estimated reward points. The reward points excess/deficit denotes an amount of excessive or insufficient reward points for the previous specified period and may be calculated by Equation 7, for example.

The parameter application unit 1330 applies a parameter to a reward points excess/deficit, wherein the parameter is determined based on a difference or ratio between an estimate and a reward points excess/deficit. For example, a parameter may be applied to a reward points excess/deficit as shown in Equation 8.

The parameter denotes a ratio at which a reward points excess/deficit for a previous specified period is applied to an estimated amount of reward points for a current specified period and may be a real number from 0 to 1. For example, if the parameter is 1, all of excessive or insufficient reward points for the previous specified period are applied to a reward estimate. If the parameter is 0, excessive or insufficient reward points for the previous specified period are not applied to a reward estimate.

The parameter application unit 1330, which applies a parameter to a reward points excess/deficit, may be included in the reward points management system 1300 as necessary. Further, the parameter may be set by an administrator of the reward points management system.

The determination unit 1340 determines reward points using the estimate reward points and the parameter-applied reward points excess/deficit. Here, the determination unit 1340 determines a total estimated amount of reward points for a current specified period using the estimate and the parameter-applied reward points excess/deficit, as shown in Equation 9.

In other words, the determination unit 1340 may apply the parameter-applied reward points excess/deficit to the reward estimate by Equation 9. If a total amount of real reward points is greater than a total estimated amount of reward points for a previous specified period, a second term of Equation 9 has a positive value. In other words, the total estimated amount of reward points for the current specified period may be determined to further have additional reward points for the previous specified period. On the contrary, if a total amount of real reward points is less than a total estimated amount of reward points for a previous specified period, the second term of Equation 9 has a negative value. In other words, the total estimated amount of reward points for the current specified period may be determined, excluding insufficient reward points for the previous specified period. The reward points management system 1300 may adjust data for the current specified period using data for the previous specified period.

The reward points management system 1300 determines a reward rate using the total estimated reward points and an estimated payment for the current specified period. For example, the reward rate may be determined by Equation 10.

The estimated payments may be determined using a real payment for a previous specified period and information about a change in a real payment for each specified period. For example, an estimated payment for the current specified period may be calculated by Equation 11.

The reward points managements system 1300 may determine a reward rate through a single operation using a single reward rate estimation function. For example, a reward rate estimation function may be expressed by Equation 12 or Equation 13.

A reward points management system according to an exemplary embodiment of the present invention may also determine a total estimated amount of reward points through a total estimated reward points determination unit (not shown) and a reward rate through a reward rate determination unit 1350. In other words, the estimate determination unit 1310, the reward points excess/deficit determination unit 1320, the parameter application unit 1330, and the determination unit 1340 of the reward points management system 1300 of FIG. 13 may be included in the total estimated reward points determination unit (not shown).

In other words, in order to perform a method for reward points management, the reward points management system may include the total estimated reward points determination unit (not shown) to determine a total estimated amount of reward points for a current specified period using an estimated advertising expense for the current specified period and a real advertising expense for a previous specified period of an advertiser allowed to provide reward points; and the reward rate determination unit 1350 to determine a reward rate applied to users for the current specified period using the total estimated amount of reward points and an estimated payment for products or services of an advertiser to be remunerated by users for the current specified period. For example, the total estimated reward points determination unit determines a total estimated amount of reward points based on an estimated advertising expense for a current specified period and may adjust the total estimated amount of reward points using the real advertising expense for a previous specified period, and the reward rate determination unit 1350 may determine a reward rate using the determined total estimated amount of reward points and an estimated payment for the current specified period.

The reward rate may include a ratio of an amount of reward points to a payment, and the advertiser allowed to provide reward points may include advertisers who apply for membership and are accepted as members among advertisers displaying advertisements through a particular site. Further, a user paying a payment may be provided with reward points. If, when an advertisement of an advertiser, accepted as a member, is provided to users through a particular site, information about the advertisement and a reward rate may be provided and a user purchasing a product or service of the advertiser through the advertisement may be provided with reward points corresponding to the reward rate.

Further, the total estimated reward points determination unit of the reward points management system according to an exemplary embodiment may determine the total estimated amount of reward points further using a ratio of the maximum amount of reward points to advertising expenses of an advertiser and a total estimated amount of reward points for a previous specified period.

In FIG. 12 and FIG. 13, a reward rate to be applied to users is determined using estimated advertising expenses for the current specified period and real advertising expenses for the previous specified period with respect to each advertiser allowed to provide reward points, and estimated payments on products or services of the advertisers to be remunerated by users for the current specified period. According to an exemplary embodiment of the present invention, however, a reward rate of all advertisers may also be determined. In this case, the aforementioned Equation 5, Equation 6, Equation 7, Equation 8, Equation 9, Equation 10, Equation 11, Equation 12, and Equation 13 may be defined with respect to all advertisers.

For example, as described in the foregoing, ‘AAₙ’ of Equation 5 denotes estimated advertising expense for an n^{th} specified period. Here, ‘AAₙ’ may denote an estimated advertising expense of a particular advertiser for an n^{th} specified period or denote estimated advertising expenses of all advertisers for the n^{th} specified period. In the same manner, Equation 11, Equation 12, and Equation 13 may be defined with respect to each individual advertiser and all advertisers.

If a reward rate is determined with respect all advertisers, as shown in FIG. 5 and FIG. 6, the same reward rate may be applied to all advertisers. If a reward rate is determined with respect to each individual advertiser, as shown in FIG. 12 and FIG. 13, a different reward rate may be applied to each individual advertiser.

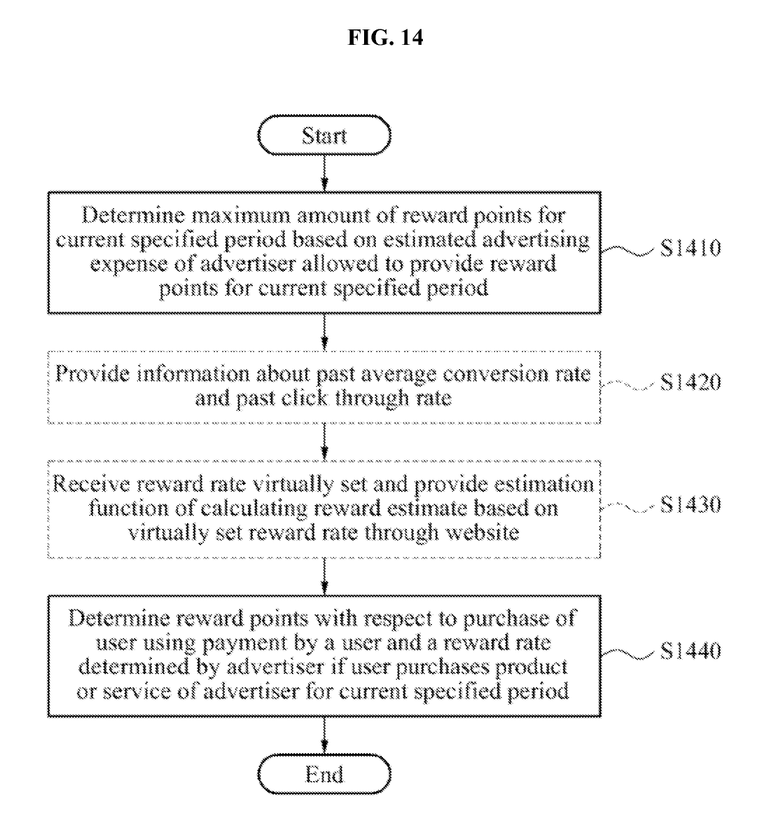

FIG. 14 is a flowchart illustrating a method for reward points management according to an exemplary embodiment of the present invention.

FIG. 14 illustrates operations of the method for reward points management conducted by the above-described reward points management system.

In operation S1410, the reward points management system determines a maximum amount of reward points for a current specified period based on estimated advertising expense of an advertiser allowed to provide reward points for the current specified period. The advertiser allowed to provide reward points may include advertisers who apply for membership and are accepted as members among advertisers displaying advertisements through a particular site.

For example, the reward points management system may determine a specific ratio of an estimated advertising expense as the maximum amount of reward points. In this case, a reward estimate for a current specified period may be defined by Equation 14.

Reward estimate=AAₙ×α [Equation 14]

Where, ‘AAₙ’ denotes an estimated advertising expense for an n^{th} specified period, and ‘α’ denotes a ratio of a maximum amount of reward points to advertising expenses of advertisers and may be a real number from 0 to 1. In other words, in Equation 14 if an n^{th} specified period is a current specified period, a specific ratio of the estimated advertising expense for the current specified period is determined as a reward estimate. The specific ratio ‘α’ may be preset. For example, if the estimated advertising expense for a current specified period is 1,000,000 won and a ratio ‘α’ of maximum reward points to the advertising expense is 0.1, a reward estimate is 100,000 won.

Further, the estimated advertising expense for the current specified period may be determined using a real advertising expense for a previous specified period and information about a change in real advertising expense for each specified period. For example, the estimated advertising expense for a current specified period may be calculated by Equation 15.

AAₙ=ƒ(RAₙ₋₁) [Equation 15]

Where, ‘RAₙ₋₁’ denotes real advertising expense for an n−1^{th} specified period, and ‘f( )’ denotes a function to estimate estimated advertising expense for an n^{th} specified period using the real advertising expense for the n−1^{th} specified period and may be one of various known functions.

Alternatively, the estimated advertising expense for a current specified period may be calculated by Equation 16.

AAₙ=ƒ(RAₙ₋₁,RAₙ₋₂,RAₙ₋₃, . . . ) [Equation 16]

Where, ‘RAₙ₋₁’ denotes real advertising expense for an n−1^{th} specified period, and ‘f( )’ denotes a function to estimate the estimated advertising expense for an n^{th} specified period based on real payments for previous specified periods including the n−1^{th} specified period and a change in a real payment for each specified period and may be one of various known functions.

Operation 1420 and operation 1430 may be conducted by the reward points management system or by another system connected to the reward points management system. For example, a system in charge of a bid of an advertiser through an advertiser page may conduct operation 1420 and operation 1430. In FIG. 14, the reward points management system conducts operation 1420 and operation 1430.

In operation S1420, the reward points management system provides information about a past average conversion rate and a number of past clicks on a keyword for each advertising display position, with respect to an advertiser. For example, the reward points management system may provide, to an advertiser, as a past average conversion rate an average conversion rate for the past one month with respect to the advertiser. Also, the reward points management system may provide, to the advertiser, as the number of past clicks a number of daily clicks for the past one month on a keyword selected by the advertiser, identified by rank. The past average conversion rate and the number of past clicks to the advertiser refers to information about the past average conversion rate and the number of past clicks and may be displayed through a page provided to the advertiser, such as, an advertiser page. The information about the past average conversion rate and the number of past clicks is provided to estimate total reward points to be generated at a reward rate determined by the advertiser, which will be described in detail in operation S1430.

Further, the reward points management system may further provide at least one of (1) information about the difference of a click through rate (CTR) or a conversion rate if reward points are applied by keywords and if reward points are not applied by keywords, (2) information about the difference of a CTR or a conversion rate according to a reward rate by keywords, (3) information about the difference of a CTR or a conversion rate with respect to an advertisement of an advertiser to provide reward points and an advertisement of the advertiser not to provide reward points, (4) information about the difference of a CTR or a conversion rate according to a reward rate in each advertisement of an advertiser, and (5) information about the history and the trends of an advertiser providing reward points.

If, when an advertiser applies reward points, the reward points management system provides, to the advertiser, information to estimate expected advertising effects due to each keyword or each advertisement of the advertiser, and may thereby induce application of reward points by the advertiser and help determine a reward rate. A reward rate may be a ratio of provided reward points to a payment paid by a user when the user purchases a product or service of the advertiser. A user paying a payment may be provided with corresponding reward points.

In operation S1430, the reward points management system may receive a reward rate virtually set and provide an estimation function of calculating a reward estimate based on the virtually set reward rate through a website. The reward estimate may be calculated using the virtually set reward rate, a payment on a product or service, a past average conversion rate, and a past CTR. For example, a reward estimate may be calculated by Equation 17.

Reward estimate=A×B×C×D [Equation 17]

Where, ‘A’ is a virtual reward rate, and ‘B’ is a payment for a product or service, i.e., a price of the product or service. Where, ‘C’ is a past average conversion rate, and ‘D’ is a past CTR.

In other words, an advertiser may determine a reward rate with respect to an advertisement using the information or function provided in operation 1420 and operation 1430. As described with reference to FIG. 5 and FIG. 6, if an advertisement of an advertiser, accepted as a member, is provided to users through a particular site, information about the advertisement and a reward rate may be provided.

In operation S1440, if a user purchases a product or service of the advertiser for a current specified period, the reward points management system determines reward points with respect to a purchase of the user using a payment by the user and the reward rate determined by the advertiser. For example, reward points with respect to a purchase of the user may be calculated by Equation 18.

Reward points=Payment×reward rate [Equation 18]

A total amount of reward points determined in operation S1440 is determined based on a payment and a number of purchases, while the maximum reward points determined in operation S1410 are determined based on advertising expense paid by an advertiser. Thus, an amount of reward points to be provided may exceed the maximum amount of reward points.

A method for reward points management according to an exemplary embodiment of the present invention may provide reward points if the total amount of reward points determined for a current specified period is equal to or less than the maximum amount of reward points. In this case, information about the reward rate may also be provided along with the advertisement through the particular site if a total amount of reward points determined for the current specified period is less than or equal to the maximum amount of reward points.

As described in the foregoing, since the advertisement and the information about the reward rate are provided on the site which users visit, it is possible to stop providing the information about the reward rate to users before a total amount of reward points determined for the current specified period exceeds the maximum amount of reward points. However, there may be a time difference between an expected moment when the total amount of reward points exceeds the maximum amount of reward points and a moment when the site which users visit stops displaying the information about the reward rate. Also, a time for a user to purchase a product after learning about the information about the reward rate from the site may also be considered. For example, a total amount of reward points may exceed the maximum amount of reward points while a user purchases a product after learning about a 0.5% reward rate.

Thus, the reward points management system and the method for reward points management may need to request the site stop providing the information about the reward rate to users prior to a period ending if a total amount of reward points exceeds the maximum amount of reward points. For example, the reward points management system and the reward points management method may request the site to stop providing the information about the reward rate at a moment when the total amount of reward points determined for the current specified period exceeds an amount of reward points *β. Where, the parameter *β may be a real number from 0 to 1. For example, the parameter *β may be 0.8.

Due to use of the parameter *β, the maximum amount of reward points may be excessive for the determined total amount of reward points. Further, despite use of the parameter *β, the maximum amount of reward points may be insufficient for the determined total amount of reward points. In these cases, the reward points management system and the method for reward points management may add the excess to the maximum amount of reward points calculated for a next specified period or may deduct the deficit from the maximum amount of reward points for a next specified period.

Further, if a total amount of reward points determined for the current specified period exceeds the maximum amount of reward points, a method for reward points management according to an exemplary embodiment of the present invention may control an excess of reward points to be covered by an advertiser. In other words, even if the total amount of reward points exceeds the maximum amount of reward points, advertisers who desire to continually provide reward points may cover an excess of reward points, thereby continually providing users with reward points.

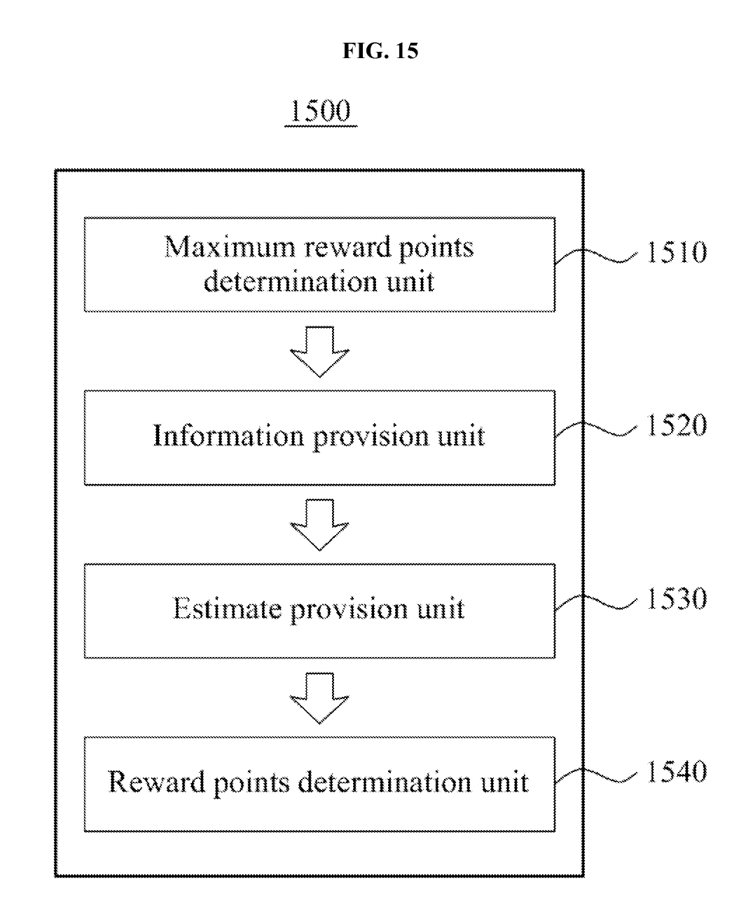

FIG. 15 is a block diagram illustrating a reward points management system according to an exemplary embodiment of the present invention.

As shown in FIG. 15, the reward points management system 1500 may include a maximum reward points determination unit 1510, an information provision unit 1520, an estimate provision unit 1530, and a reward points determination unit 1540.

The maximum reward points determination unit 1510 determines a maximum amount of reward points for a current specified period based on an estimated advertising expense of an advertiser allowed to provide reward points for the current specified period. The advertiser allowed to provide reward points may include advertisers who apply for membership and are accepted as members among advertisers displaying advertisements through a particular site.

For example, the maximum reward points determination unit 1510 may determine a specific ratio of an estimated advertising expense as the maximum amount of reward points. In this case, a reward estimate for a current specified period may be defined by Equation 14.

Further, the estimated advertising expense for the current specified period may be determined using a real advertising expense for a previous specified period and information about a change in the real advertising expense for each specified period. For example, the estimated advertising expense for a current specified period may be calculated by Equation 15 or Equation 16.

The information provision unit 1520 and the estimate provision unit 1530 may be included in the reward points management system 1500 or may be included in another system connected to the reward points management system 1500. For example, a system in charge of a bid of an advertiser through an advertiser page may include the information provision unit 1520 and the estimate provision unit 1530. In FIG. 15, the reward points management system 1500 includes the information provision unit 1520 and the estimate provision unit 1530.

The information provision unit 1520 provides information about a past average conversion rate and a number of past clicks on a keyword for each advertising display position, with respect to an advertiser. For example, an information provision unit 1520 may provide, to an advertiser, as a past average conversion rate an average conversion rate for the past one month with respect to the advertiser. Also, the information provision unit 1520 may provide, to the advertiser, as a number of past clicks a number of daily clicks for the past one month on a keyword selected by the advertiser, identified by ranking.

The past average conversion rate and the number of past clicks to the advertiser refers to information about the past average conversion rate and the number of past clicks and are displayed through a page provided to the advertiser, such as, an advertiser page. The information about the past average conversion rate and the number of past clicks is provided to estimate a total amount of reward points to be generated at a reward rate determined by the advertiser, which will be described in detail with the estimate provision unit 1530.

Further, the information provision unit 1520 may further provide at least one of (1) information about the difference between a CTR or conversion rate if reward points are applied by keywords and if reward points are not applied by keywords, (2) information about the difference of a CTR or a conversion rate according to a reward rate by keywords, (3) information about the difference of a CTR or a conversion rate with respect to an advertisement of an advertiser to provide reward points and an advertisement of the advertiser not to provide reward points, (4) information about the difference of a CTR or a conversion rate according to a reward rate in each advertisement of an advertiser, and (5) information about the history and the trends of an advertiser providing reward points.

If an advertiser applies reward points, the information provision unit 1520 provides, to the advertiser, information to estimate expected advertising effects due to each keyword or each advertisement of the advertiser, and may thereby induce application of reward points by the advertiser and help determine a reward rate. A reward rate may be a ratio of provided reward points to a payment remunerated by a user when the user purchases a product or service of the advertiser. A user paying a payment may be provided with corresponding reward points.

The estimate provision unit 1530 receives a reward rate virtually set and provides an estimation function for calculating a reward estimate based on the virtually set reward rate through a website. Here, the reward estimate may be calculated using the virtually set reward rate, a payment on a product or service, a past average conversion rate, and a number of past clicks. For example, a reward estimate may be calculated by Equation 17.

In other words, an advertiser may determine a reward rate with respect to an advertisement using the information or function provided through the information provision unit 1520 or the estimate provision unit 1530. As described in the foregoing with reference to FIG. 4 and FIG. 5, if an advertisement of an advertiser, accepted as a member, is provided to users through a particular site, information about the advertisement and a reward rate may be provided.

If a user purchases a product or service of the advertiser during a current specified period, the reward points determination unit 1540 determines an amount of reward points with respect to purchase of the user using a payment by the user and the reward rate determined by the advertiser. For example, an amount of reward points with respect to purchase of the user may be calculated by Equation 18.

Total reward points determined by the reward points determination unit 1540 are determined based on a payment and a number of purchases, while the maximum reward points determined by the maximum reward points determination unit 1510 are determined based on advertising expense paid by an advertiser. Thus, reward points to be provided may exceed the maximum reward points allotted.

The reward points management system 1500 according to the present exemplary embodiment may provide reward points if a total amount of reward points determined for a current specified period is equal to or less than the maximum reward points. Information about the reward rate may also be provided along with the advertisement through the particular site if the total amount of reward points determined for the current specified period is equal to or less than the maximum amount of reward points.

As described in the foregoing, since the advertisement and the information about the reward rate are provided on the site which users visit, it is possible to stop providing the information about the reward rate to users before the total amount of reward points determined for the current specified period exceeds the maximum amount of reward points. However, there may be a time difference between an expected moment when the total amount of reward points exceeds the maximum amount of reward points and a moment when the site which users visit stops displaying the information about the reward rate. Also, time for a user to purchase a product after learning about the information about the reward rate from the site may also be considered. For example, a total amount of reward points may exceed the amount of maximum reward points while a user purchases a product after learning about a 0.5% reward rate.

Thus, the reward points management system and the method for reward points management may need to request the site stop providing the information about the reward rate to users prior to a period ending if the total amount of reward points exceeds the maximum amount of reward points. For example, the reward points management system and the reward points management method may request the site to stop providing the information about the reward rate at a moment when the total amount of reward points determined for the current specified period exceeds an amount of reward points *β. Where, the parameter *β may be a real number in the range from 0 to 1.

Due to use of the parameter *β, the maximum reward points may be excessive for the determined total reward points. Further, despite use of the parameter β, the maximum reward points may be insufficient for the determined total reward points. In these cases, the reward points management system and the method for reward points management may add the excess to maximum reward points calculated for a next specified period or may deduct the deficit from maximum reward points for a next specified period.

Further, if a total amount of reward points determined for the current specified period exceed the maximum amount of reward points, a reward points management system 1500 according to an exemplary embodiment of the present invention may control an excess of reward points to be covered by an advertiser. In other words, even if the total amount of reward points exceeds the maximum amount of reward points, advertisers who desire to continually provide reward points may cover an excess of reward points, thereby continually providing users with reward points.

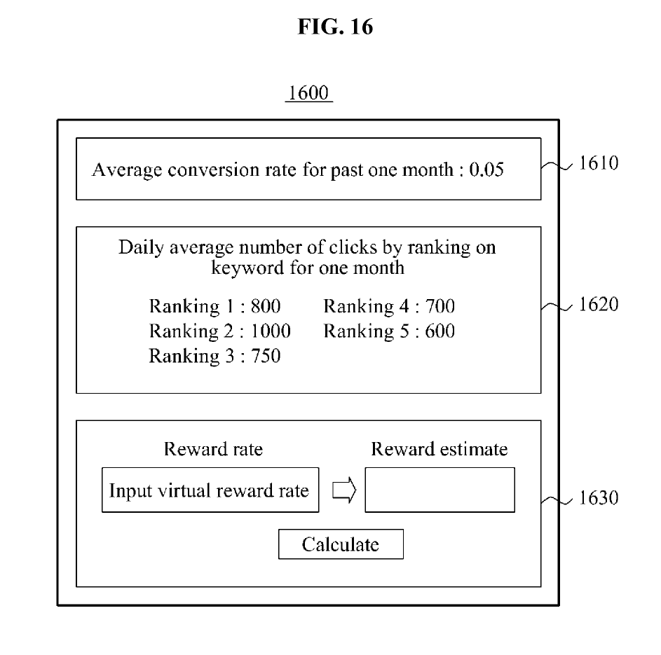

FIG. 16 illustrates a webpage provided to an advertiser according to an exemplary embodiment of the present invention.

On the webpage 1600, a first dotted-line box 1610 illustrates an average conversion rate for the past one month with respect to an advertiser. Here, ‘0.05’ indicates that 5 percent or 5 out of 100 users who select an advertisement of the advertiser and access the advertisement page conduct an action induced by the advertiser. For example, if 30,000 users select the advertisement and access the advertisement page for the past one month, 1,500 users from among the 30,000 users purchased products or services of the advertiser.

A second dotted-line box 1620 indicates a number of clicks by rank on a keyword A selected by the advertiser for a day on average in one month. The number of clicks may mean a number of times users select an advertisement. In other words, an advertisement displayed in a first ranking with respect to the keyword A was selected 800 times a day on average for the past one month, and an advertisement displayed in a second ranking was selected 1,000 times a day on average for the past one month.

A third dotted-line box 1630 indicates a user interface to notify the advertiser of a reward estimate for a specified period and to help determine a reward rate. The reward estimate may be calculated by Equation 17. A payment amount for a product or service is determined, a past average conversion rate may be determined using an average conversion rate for the past one month, and a past CTR may be determined using one of the rankings selected by the advertiser from among daily average numbers of clicks on the keyword A for one month. In other words, if the advertiser inputs a virtual reward rate, the user interface calculates a reward estimate and provides the reward estimate to the advertiser.

As described in the foregoing, a reward points management system and a method for reward points management according to exemplary embodiments of the present invention provide reward points to a user if the user purchases a product or service of an advertiser through a displayed advertisement of the advertiser, determines a maximum amount of reward points based on advertising expense of the advertiser for a specified period, and divides the maximum amount of reward points based on a rate of a payment paid by the user.

Further, the reward points management system and the method for reward points management provide reward points to a user if the user purchases a particular product or service or purchases products or services on a particular site, and may thereby draw the user's attention and accordingly may improve the efficiency of an advertising of advertisers having membership. Further, a medium that attracts the interests of advertisers with increasing advertising efficiency and thus earns advertising revenues.

In addition, the reward points management system and the reward points management method determine a reward rate with respect to a payment by a user using estimated advertising expense and an estimated payment for a current specified period estimated based on actual advertising expense and an actual payment for a previous specified period, and maintain reward points of a user by supplying excess reward points or stopping a display of reward information and reward points to a user depending on a choice of the advertiser if a sum of reward points exceeds maximum reward points.

The exemplary embodiments according to the present invention may be recorded in a non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as, hard disks, floppy disks, and magnetic tape; optical media such as, CD ROM discs and DVD; magneto-optical media such as, floptical disks; and hardware devices that are specially configured to store and perform program instructions, such as, read-only memory (ROM), random access memory (RAM), flash memory, and the like. Examples of program instructions include both machine code, such as, produced by a compiler, and files containing a higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A reward points management system comprising:
a storage medium;
a maximum reward points determination unit stored on the storage medium and configured to determine a maximum amount of reward points of an advertiser allowed to provide reward points on a site, the maximum amount of reward points being based on an advertising expense for a specified period; and
a reward points determination unit stored on the storage medium and configured to determine an amount of reward points for a user based on a payment remunerated by the user for a product or service of the advertiser and the determined maximum amount of reward points.

2. The reward points management system of claim 1, wherein the maximum reward points determination unit determines a specific ratio of the advertising expense for the specified period as the maximum amount of reward points for the specified period.

3. The reward points management system of claim 1, wherein the reward points determination unit calculates a ratio of a payment remunerated by the user to total payments and divides the maximum amount of reward points by the calculated ratio to determine the reward points of the user.

4. The reward points management system of claim 1, further comprising
a reward points addition unit to add the determined amount of reward points to a total amount of reward points of the user; and
a reward points deduction unit to deduct used reward points from the total amount of reward points of the user based on information received from the site of the advertiser in response to a product or service being purchased on the site using the reward points of the user.

5. The reward points management system of claim 1, wherein the advertiser comprises an advertiser who applies for membership and is accepted as a member of the advertisers who display advertisements through a particular site.

6. The reward points management system of claim 5, wherein the system provides information about an advertisement and information about the reward points in response to the advertisement of the advertiser being provided to the users through the particular site.

7. A reward points management method comprising:
determining a maximum amount of reward points of an advertiser allowed to provide reward points through a first site, the maximum amount of rewards points being based on advertising expenses for a specified period;
determining an amount of reward points for a user based on a payment remunerated by the user for a product or service of the advertiser through a second site; and
deducting an amount of reward points from determined reward points of the user.

8. The reward points management method of claim 7, wherein the determining of the maximum amount of reward points comprises determining a specific ratio of the advertising expenses for the specified period to be the maximum amount of reward points for the specified period.

9. The reward points management method of claim 7, wherein the determining of the reward points comprises calculating a ratio of a payment remunerated by a user to total payments for products and services of the advertiser and dividing the maximum amount of reward points by the calculated ratio to determine the reward points of the user.

10. The reward points management method of claim 7, further comprising:
adding the determined amount of reward points to a total amount of reward points of the user; and
deducting used reward points from the total amount of reward points of the user based on information received from the second site of the advertiser in response to a product or service being purchased on the second site.

11. The reward points management method of claim 7, wherein the advertiser allowed to provide the reward points through the first site comprises an advertiser who applies for membership and is accepted as a member among advertisers displaying advertisements through a the first site.

12. The reward points management method of claim 11, further comprising providing information about an advertisement and information about the reward points in response to the advertisement of the advertiser being provided to the users through the first site.

13. The reward points management method of claim 7, wherein the first site and the second site are the same site.

14. The reward points management method of claim 7, wherein the first site and the second site are different sites.

15. A non-transitory computer-readable recording medium storing a program to implement the method of claim 7.

16. A rewards point management system comprising:
in a non-transitory computer readable medium:
a maximum reward points determination unit to determine a maximum amount of reward points of an advertiser for purchases made through a site, the maximum amount of rewards points being based on an advertising expense for a specified period;
a reward points determination unit to determine reward points for a user who purchases the advertiser's products or services through the site based on a payment remunerated by the user for the product or service of the advertiser and the determined maximum amount of reward points;
a reward points addition unit to add the determined amount of reward points to a total amount of reward points of the user; and
a reward points deduction unit to deduct used reward points from the total amount of reward points of the user based on information received from the site in response to a product or service being purchased on the site using the reward points of the user.
